(19) United States
(12) Patent Application Publication
(10) Pub. No.: US 2004/0008211 A1
(43) Pub. Date: Jan. 15, 2004

(54) Display device

(76) Inventors: Gregory John Soden, Annerley (AU); Michael George Alcorn, Bowen Hills (AU)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/447,259

(22) Filed: May 29, 2003

Related U.S. Application Data
(63) Continuation of application No. PCT/AU01/01561, filed on Nov. 30, 2001.

(30) Foreign Application Priority Data
Nov. 30, 2000 (AU) PR1818

(51) Int. Cl. G09G 5/00

(52) U.S. Cl. 345/623; 345/716

(57) ABSTRACT

The invention relates to a display device (10) incorporating an image (11) and an associated solid state audio recording (24) related to the image. The display device (10) comprises one or more still images having a predetermined content and has a solid state audio playback apparatus (24), preferably a digital playback apparatus, having audio output means (21), data storage means (24) for storing an audio signal of a duration greater than thirty seconds at a sound quality of not less than 22 kb per second (commonly referred to a “radio quality”). The content of the audio output relates to the content of the image (11) or images. The image (11) or images may relate for example to noteworthy sporting events or personalities and the audio playback may relate to sporting commentaries relating to that event or personality.

This invention relates to a display device incorporating an image and an associated solid state audio recording related to the image.

It is common to see various framed images, some of these having associated audio. The most notable of these is the television where a video image has an associated sound track. The cinema is another example. Sound is common in the area of computers where still images have associated midi or wave files that play a sound. However, to date, even having regard to the technological advances in solid state sound recording and playback chips that have been in common use for many years the present combination has not been invented. Moreover, there has not been a simple, cost effective solution to provide high quality audio associated with a still image such as a photograph of a historical event or an advertising poster.

Recorded messages on magnetic audio tape or other recording media are expensive to mass produce and are not maintenance free so it would be desirable to provide a solid state solution that provides quality sound in combination with a still image or images with an interrelationship between the image(s) and the audio.

Of course, solid state sound recording and/or playback devices are well known. For example, one is able to purchase greeting cards that have a small piezoelectric speaker and sound chip that plays a short tune or message when the greeting card is opened. Likewise, digital watches commonly include alarms that play a tune. These have been available for at least 15 years. Mobile phones also carry various different tunes that play instead of a simple ringing sound. It is common to have solid state telephone answering machines. Nevertheless, despite the long time availability of the technology the present invention in the combination set out below has not arisen.

It is an object of the present invention to provide a display device which provides high quality audio accompaniment.

According to the present invention there is provided a display device comprising one or more still images having a pre-determined content, the device having a solid state audio playback apparatus, the playback apparatus having audio output means, data storage means for storing an audio signal of a duration greater than thirty seconds at a sound quality of not less than 22 kb per second (commonly referred to a “radio quality”) and where the content of the audio output relates to the content of the image or images.

Preferably, the audio output (or audio message) has a duration exceeding one minute and typically has capacity for up to four minutes duration. While this is considered sufficient for most purposes it is clearly possible to provide longer time periods by employing greater memory although this is at a trade off of greater expense.

Preferably the data storage means is a digital data storage means.

The display device preferably includes a frame housing the image (or images) as a two dimensional image such as a framed photograph or painting. The solid state sound playback unit is preferably housed within the frame at an upper end thereof. One or preferably two speakers are employed also housed in or attached to the frame. Where two speakers are employed they are positioned at even spacing across the frame to provide uniform sound distribution.

In a particularly preferred embodiment the frame is arranged so that sound exists from a concealed or disguised sound passage. One or more sound passages may be involved. Typically, the concealed sound passage is defined by an aperture in the frame covered by a sound permeable membrane. More preferably a sound impermeable plate is employed such that the sound is redirected to exit via an opening adjacent the plate. Preferably the frame includes a concave or similar surface and the plate bridges across the surface so that sound exits through openings defined either side of the plate between the plate and the frame, the surface typically extending around the entire frame.

The plate is preferably located centrally at the top of the frame so that when the frame is hung on a wall sound projects evenly, outwardly and downwardly through openings on either side of the plate. The plate is typically a plaque.

The unit may be operated by a switch that can be manually depressed to reset the recording and start the audio playback from the beginning. Alternatively, a proximity switch may be used in addition or as an alternative to the push button switch so that playing of the audio output is automatically started when a person comes into sufficient proximity to the device.

In its simplest form the device is pre-loaded with the digitised audio signal but may be fully programmable and re-recordable in function. It is preferably battery powered and able to operate in a low power standby mode.

In a more preferred embodiment, the device includes the ability for the audio playback message to be changed from time to time. Most preferably this is done by way of a removable memory device, where an alternative memory device or a device which holds digital audio data different to that which was originally programmed into the audio playback apparatus, can be inserted into a suitable port in the device. Most preferred memory devices include flash memory cards or Memory Sticks (trade mark). The memory device may contain the digital audio data such as digital voice and/or digital music that has been stored in, for example MP3 format using suitable software.

In another embodiment, optional audio data files may be available to the user, for example, downloadable from the Internet onto a flash card or Memory Stick (trade mark) which may then be inserted into the display device. It will be appreciated that alternative arrangements for loading digitised audio signals into the device may be utilised.

In an especially preferred form the elements of the device including the speakers are concealed or the device is otherwise disguised so that it appears as an ordinary painting, picture or framed photograph or the like in order to provide some surprise effect when the audio playback commences. For example, the image or images may relate to noteworthy sporting events or personalities and the audio playback may relate to sporting commentaries relating to that event or personality. Alternatively, the image may be of a famous political figure commemorating a particular historical speech and the sound recording may be extracts from the actual speech. Another example, may be an advertisement and the sound may be the associated advertising jingle.

In order that the present invention can be more readily understood and be put into practical effect, reference will now be made to the accompanying drawings which illustrate one preferred embodiment and wherein:

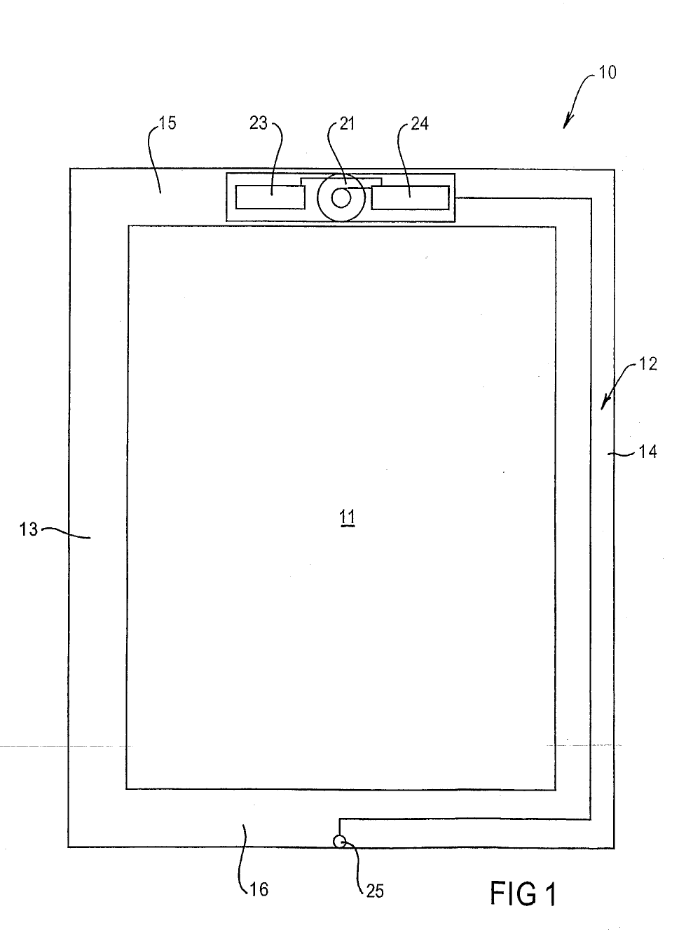

FIG. 1 is a schematic of a device according to the present invention;

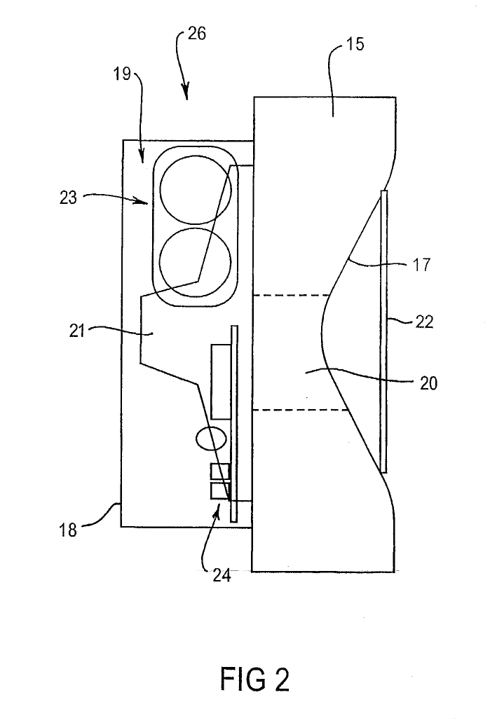

FIG. 2 is a section through 2-2 of FIG. 1;

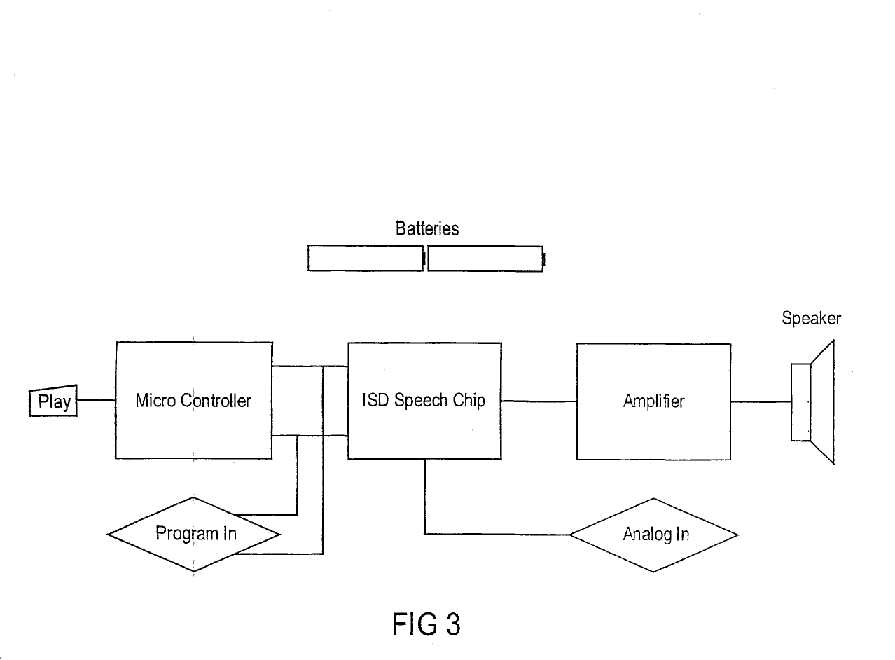

FIG. 3 is a block diagram of a recording and playback unit; and

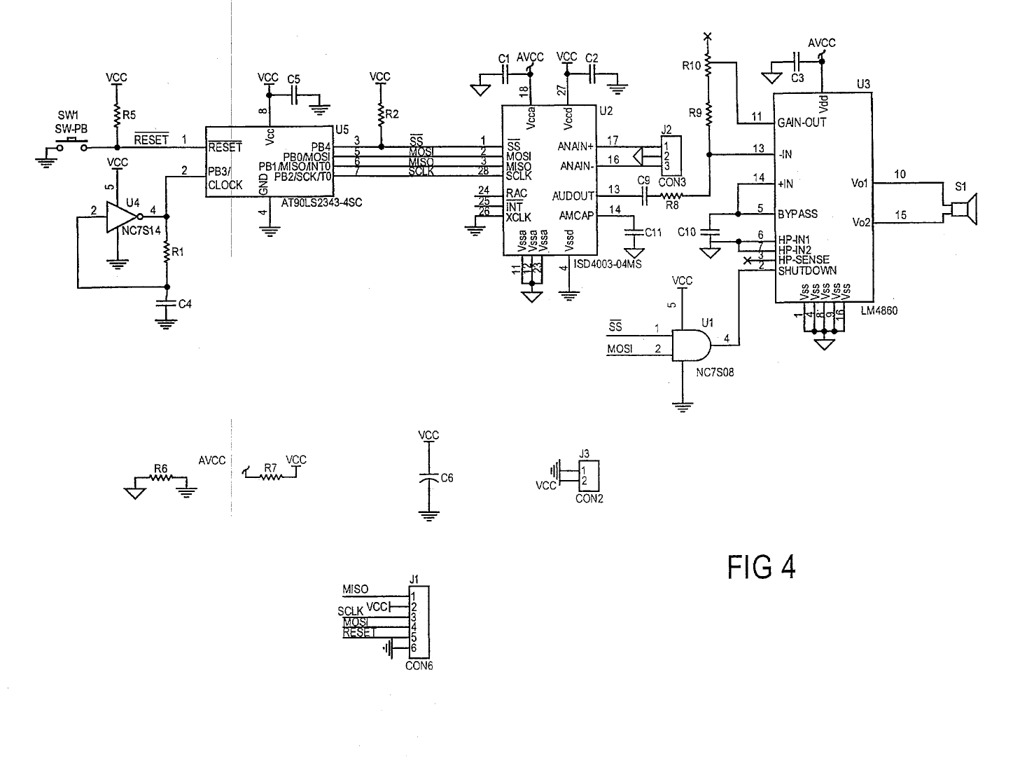

FIG. 4 is a circuit diagram of a typical recording and playback unit.

Referring to the drawings and initially to FIGS. 1 and 2 there is illustrated a display device 10 comprising an image 11 held within a frame 12 in known fashion, the frame 12 includes side frame members 13 and 14, top frame member 15 and bottom frame member 16. In this case the top frame member 15 includes a front concave surface section 17 and behind the top frame member a housing section at 18 which holds a sound recording and playback unit 19. A hole 20 through the frame member 17 allows sound from a speaker 21 to impinge on a plaque 22 (not shown in FIG. 1) which conceals the hole 20. Sound flows sideways along the concave surface 17 to exit between the concave surface and the plaque on either side of the plaque. The plaque can carry indicia related to the image, this may be a title or other information. Batteries are illustrated at 23 and a printed circuit board and electronic components at 24 within housing 18. The frame members 13, 14, 15 and 16 may all be made from the same section so that the concave surface 17 extends around the entire frame. A proximity switch may be employed so that playback of the sound message commences when a person walks within a certain range of the image.

In the illustrated embodiment a push button 25 is employed in the frame 16 should it be desirable to reset and start playback of the sound recording using a manually operable switch rather than the proximity switch. A proximity over-ride switch may be employed also on the base of the frame 16 so that the manual or proximity operation can be selected. The switches are housed in recesses in the frame 16 and are there concealed from the front.

The frame is typically hung with the frame member 16 against a wall and the frame members 13 and 14 are inclined upwardly with the housing 18 projecting into a space 26 between the frame member 16 and the wall, thus accommodating the housing 18 and also directing the sound outward and downward toward persons viewing the image.

Referring to FIG. 3 there is illustrated in block diagram form the principal elements of the recording and playback unit. Clearly the arrangement illustrated in block diagram of FIG. 3 can be embodied in various ways although FIG. 4 illustrates a specific embodiment described as follows:

The electronics can be divided into three sections.

1. The controlling unit, an Atmel micro-controller, AT90LS2343-4SC.

2. The speech recording unit, an ISD chipcorder, ISD4003-04MS.

3. The analog amplifier, a National Semiconductor, LM4860.

1. The Micro-Controller:

The AT90LS2343 is a 3V, 8 pin, 4 MHz micro-controller (U5). The internal oscillator, in the 2343, sometimes does not start and then the controller defaults to the external clock source. A RC oscillator (U4, R1 & C4) was added to the design to overcome this problem. This leaves the controller with only four IO lines, these are used to emulate the SPI communication t the ISD chip. SPI needing, MOSI (Master-out/Slave-in), MISO (Master-In/Slave-Out), SCLK (Serial Clock), and /SS (Slave Select).

After a reset the controller will send out a command to the ISD chip to power up and then to play from the start of memory. A delay will elapse and the controller will send a power down command to the ISD chip, shut down the LM4860 amp and then put itself to sleep.

The controller can be reprogrammed in-system through the connector CON6, resistor R2 pulls /SS high to ensure that the ISD chip does not try to interpret any of the programming commands to the controller.

2. ISD Chip:

This chip, the ISD4003-04MS (U2), is the core of the whole system, it can have up to 4 mins of 8 ksps speech stored in it. These four minutes can be split into many different fragments. The ISD chip is very self-contained; the SPI interface facilitates the control, an analog input to record and an analog output to run directly into the amplifier.

The analog input can be fed directly into the system through CON3 and commands to the ISD chip can be sent through the same connector as is used to program the controller (CON6).

3. Amplifier:

A 2W peak amplifier from National Semiconductor, the LM4860 (U3), is used to drive the 8 ohm speaker. This is one of the few amplifiers, which are designed to run at low voltages (i.e. 3V). It also has a shutdown feature, which is able to reduce the power consumption dramatically. Although it is very important to be able to drive this line, the Atmel part does not have enough IO lines to do so. To overcome this problem the /SS line to the ISD chip is ANDed (U1) with the MOSI line to produce the shutdown line. This means that the amp is always active during the sending of a command to the ISD chip, but when the controller is not sending a command it has control of the shutdown line through use of the MOSI line.

The use of the ISD chipcorder enables the saving of voice and audio into Flash-based memory cells with a natural form, without any analog to digital and digital to analog converting circuits. Without any compression and decompression processes in saving directly the voice and audio signals, further quality of sound is achieved.

The ISD chipcorder's multi-level storage provides digital modifications and is a variation to the example providing CD quality mono, or stereo sound.

In yet another preferred embodiment of the invention, there may additionally be provided a security device either electronically or physically incorporated within the circuitry of the display device. The security device may include features such as identification or confirmation of the authenticity of the display device or identity of the present owner of the device in case the display device is stolen. The security device may be electronically read or scanned or programmed as desired to perform the necessary or desirable security function.

Whilst the above has been given by way of illustrative example of the present invention many variations and modifications thereto will be apparent to those skilled in the art without departing from the broad ambit and scope of the invention as herein set forth.

1. A display device comprising:
one or more still images having a predetermined content;
a solid state audio playback apparatus including audio output means, data storage means for storing an audio signal of a duration greater than thirty seconds of a sound quality of not less than 22 kb per second data processor means for converting said digitised audio signal into an audio output;
such that the audio output is playable for a period of in excess of thirty seconds at a sound quality of not less than 22 kb per second wherein the content of the audio output relates to the content of the image.

2. A display device according to claim 1 wherein said data storage means is a digital data storage means.

3. A display device according to claim 2 wherein the digital data storage means can store a digitised audio signal of a duration exceeding one minute.

4. A display device according to claim 3 wherein the digital data storage means can store a digitised audio signal of a duration exceeding four minutes.

5. A display device according to any one of claims 1 to 4 wherein said one or more images are displayed within a frame, and said solid state audio playback apparatus is housed within said frame.

6. A display device according to claim 5 wherein said audio output means comprises one or more speakers concealed within said frame.

7. A display device according to claim 5 wherein the audio output means includes a sound passage concealed by a sound impermeable plate, said sound passage having concealed openings adjacent said plate.

8. A display device according to any one of claims 2 to 7 wherein said digital data storage means include a removable memory device which is replaceable by a user, said memory device containing digital audio information.

9. A display device according to claim 8 wherein said device includes a dock into which said removable memory device may be inserted for transfer of data to said device.

10. A display device according to claim 8 or 9 wherein different audio outputs are playable by inserting removable memory devices containing different digital audio information.

11. A display device according to any one of claims 1 to 10 wherein said device further includes a proximity switch which initiates playing of said audio output when triggered by the presence of a listener.

12. A display device according to claim 1 substantially as herein before described with reference to the drawings.
